(19) United States
(12) Patent Application Publication
(10) Pub. No.: US 2021/0274035 A1
(43) Pub. Date: Sep. 2, 2021

(54) METHOD FOR ANTI-DISTURBING, ELECTRONIC DEVICE, AND COMPUTER-READABLE STORAGE MEDIUM

(71) Applicant: Shenzhen Royole Technologies Co., Ltd., Shenzhen (CN)

(72) Inventor: Tong Wu, Shenzhen (CN)

(21) Appl. No.: 17/320,383

(22) Filed: May 14, 2021

Related U.S. Application Data
(63) Continuation of application No. PCT/CN2018/115377, filed on Nov. 14, 2018.

(51) Int. Cl. H04M 1/72484; H04M 1/72454; H04M 1/72469; H04M 1/02; G06F 3/0481

(52) U.S. Cl. CPC H04M 1/72484; H04M 1/72454; G06F 3/04817; H04M 1/0216; H04M 1/0268; H04M 1/72469

(57) ABSTRACT

A method for anti-disturbing includes: creating a prompt information window and displaying the prompt information window when a prompt information is received while the electronic device is in an immersion mode, wherein the prompt information is displayed in the prompt information window; creating a floating icon and controlling the floating icon to be displayed in the prompt information window; acquiring position data in a three-dimensional space of the electronic device by the sensor, and controlling the floating icon to move based on the position data; and controlling the electronic device to perform a function corresponding to movement of the floating icon.

### CROSS-REFERENCE TO RELATED APPLICATIONS

This application is a continuation of International Application No. PCT/CN2018/115377, with an international filing date of Nov. 14, 2018, titled “METHOD FOR ANTI-DISTURBING, ELECTRONIC DEVICE, AND COMPUTER-READABLE STORAGE MEDIUM”, the entire contents of which are incorporated herein by reference.

### TECHNICAL FIELD

The present disclosure relates to the technical field of communications, and in particular, relates to a method for anti-disturbing, an electronic device, and a computer-readable storage medium.

### BACKGROUND

With the development of electronic technologies, more and more applications are installed in an electronic device (for example, a mobile phone), and more and more prompt information of these applications are generated and displayed. When a user opens an application, the prompt information of other applications may be usually received. For example, when the user is playing games by using the electronic device, in response to receiving prompt information, for example, a short message, incoming call reminding information, or prompt information of other applications, the electronic device may display the prompt information in a particular manner on a game interface. If the received prompt information needs to be responded to (for example, viewed), a current game interface needs to be exited, which causes a display image of the current application of the user to be interrupted, and affects user experience.

### SUMMARY

Embodiments of the present disclosure provide a method for anti-disturbing, being applied to an electronic device, wherein the electronic device includes a display screen and a sensor. The method includes:

creating a prompt information window and displaying the prompt information window when a prompt information is received while the electronic device is in an immersion mode, wherein the prompt information is displayed in the prompt information window;

creating a floating icon and controlling the floating icon to be displayed on the prompt information window;

acquiring position data in a three-dimensional space of the electronic device by the sensor, and controlling the floating icon to move based on the position data; and

controlling the electronic device to perform a function corresponding to movement of the floating icon.

Embodiments of the present disclosure further provide an electronic device. The electronic device includes a display screen, a sensor, and a processor; wherein the sensor is configured to sense position data of the electronic device in a three-dimensional space, wherein the processor is configured to create a prompt information window and display the prompt information window when a prompt information is received while the electronic device is in an immersion mode, wherein the prompt information is displayed in the prompt information window; and

the processor is further configured to create a floating icon and control the floating icon to be displayed in the prompt information window, control the floating icon to move based on the position data, and control the electronic device to perform a function corresponding to movement of the floating icon.

Embodiments of the present disclosure further provide a computer-readable storage medium, storing a control program for performing the method for anti-disturbing; wherein the control program, when running on a processor, causes the processor to perform the method as described above.

### BRIEF DESCRIPTION OF THE DRAWINGS

For clearer descriptions of technical solutions according to the embodiments of the present disclosure, drawings that are to be referred for description of the embodiments are briefly described hereinafter. Apparently, the drawings described hereinafter merely illustrate some embodiments of the present disclosure. Persons of ordinary skill in the art may also derive other drawings based on the drawings described herein without any creative effort.

FIG. 1 is a flowchart of a method for anti-disturbing according to an embodiment of the present disclosure;

FIG. 2 is a schematic structural diagram of a display screen according to an embodiment of the present disclosure;

FIG. 3 is a schematic diagram of a relationship between a prompt information window and an application interface in an immersion mode according to an embodiment of the present disclosure;

FIG. 4 is a schematic diagram of a relationship between a prompt information window and an application interface in an immersion mode according to another embodiment of the present disclosure;

FIG. 5 is a flowchart of a method for anti-disturbing according to another embodiment of the present disclosure;

FIG. 6 is a flowchart of a method for anti-disturbing according to still another embodiment of the present disclosure; and

FIG. 7 is a structural block diagram of an electronic device according to an embodiment of the present disclosure.

### DETAILED DESCRIPTION

The technical solutions contained in the embodiments of the present disclosure are described in detail clearly and completely hereinafter with reference to the accompanying drawings for the embodiments of the present disclosure. Apparently, the described embodiments are only a portion of embodiments of the present disclosure, but not all the embodiments of the present disclosure. Based on the embodiments of the present disclosure, all other embodiments derived by persons of ordinary skill in the art without any creative efforts shall fall within the protection scope of the present disclosure.

It should be noted that the terminology used in the embodiments of the present disclosure is for the purpose of describing particular embodiments only and is not intended to limit the present disclosure. As used in the embodiments of the present disclosure and the appended claims, the singular forms “a/an,” “the,” and “said” are intended to include the plural forms as well, unless the context clearly indicates otherwise. It shall also be understood that the term “and/or” used herein is intended to signify and include any or all possible combinations of one or more of the associated listed items.

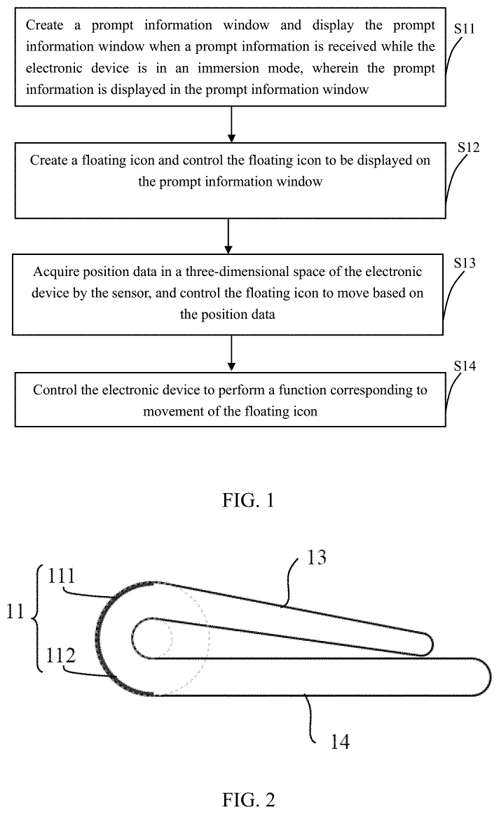

Referring to FIG. 1, FIG. 1 is a flowchart of a method for anti-disturbing according to an embodiment of the present disclosure. The method for anti-disturbing is applied on an electronic device. The electronic device includes a display screen and a sensor. The method for anti-disturbing includes the following steps:

In step S11, a prompt information window is created and displayed when a prompt information is received while the electronic device is in an immersion mode, the prompt information is displayed in the prompt information window.

The immersion mode may be a game mode, a viewing mode, a meeting mode, or the like. The game mode refers to a mode in which the electronic device is currently running a game application in a full screen; the viewing mode refers to a mode in which the electronic device is currently displaying a video in the full screen; and the meeting mode refers to a mode in which the electronic device is active in the full screen and in a multi-person voice or video call. The electronic device being in the immersion mode indicates that a user is concentrating on what he is doing by using the electronic device. For example, the user is playing game, watching a movie, making a meeting call with another user, or the like. In this case, the user does not want to be disturbed by the received prompt information.

In this embodiment, in response to a function of the immersion mode of the electronic device being enabled, the electronic device is in the immersion mode. In response to the function of the immersion mode of the electronic device being disabled, the electronic device is not in the immersion mode. The immersion mode may be enabled or disabled by a physical key configured on the electronic device, or by a function icon/touch key displayed on the display screen, or by inputting a specific gesture to the display screen, which is not limited in the embodiment of the present disclosure. As such, the user may select whether or not to enter the immersion mode, which better accommodates the user's needs, and further improves user experience.

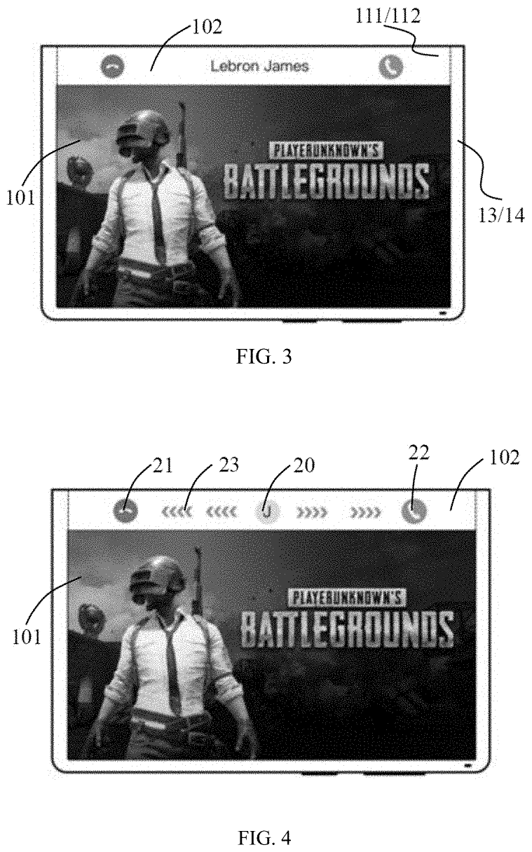

Referring to FIG. 2 and FIG. 3, in some embodiments, the display screen is a flexible display screen. The flexible display screen may be an organic light-emitting diode (OLED) flexible display screen, which has characteristics of bendability, twistability, and foldability, and meanwhile has features of better color and contrast, and ultimately thinness. In this embodiment, the flexible display screen includes a bending region 11. When the electronic device is in a folding state, the flexible display screen is partitioned by the bending region 11 into a primary screen region 13 and a secondary screen region 14. An orientation of the primary screen region 13 is opposite to an orientation of the secondary screen region 14. When the electronic device is in an unfolding state, the primary screen region 13, the bending region 11, and the secondary screen region 14 form a contiguous plane. The folding state refers to a state in which an included angle between two parts of the electronic device partitioned by the bending region 11 is less than 180 degrees. When the included angle between the two parts is 180 degrees, the electronic device is in the unfolding state. In this embodiment, that the prompt information window is displayed includes: the electronic device is controlled to display the prompt information window in the bending region 11, and the electronic device is controlled to display an application interface 101 of an application in the primary screen region 13 or the secondary screen region 14 while the electronic device is in the immersion mode.

In some embodiments, the bending region 11 defines a folding line. The bending region 11 is partitioned by the folding line into a first side screen region 111 and a second side screen region 112, wherein the primary screen region 13 is connected to the first side screen region 111, and the secondary screen region 14 is connected to the second side screen region 112. When the display screen is in the folding state, the first side screen region 111 and the second side screen region 112 of the bending region 11 form a contiguous arc surface. When the display screen is in the unfolding state, the first side screen region 111 and the second side screen region 112 of the bending region 11 form a contiguous plane.

In this embodiment, When the application interface 101 is displayed in the primary screen region 13 of the display screen, a prompt information window 102 is controlled to be displayed in the first side screen region 111; or, When the application interface 101 is displayed in the secondary screen region 14 of the display screen, the prompt information window 102 is controlled to be displayed in the second side screen region 112. In this embodiment, the prompt information window 102 and the application interface 101 in the immersion mode are separately displayed, such that the prompt information window 102 does not cover a currently displayed application interface 101. Furthermore, it is not affected the user's watching the current application interface. In addition, since the first side screen region 111 or the second side screen region 112 deviates from a visual center of the user, distraction of the user's attention is decreased, and user experience is further improved.

In step S12, a floating icon 20 is created and controlled to be displayed on the prompt information window 102.

In some embodiments, that the floating icon 20 is created and controlled to be displayed on the prompt information window 102 includes: responding to a received particular operation and the floating icon 20 is created, and then the floating icon 20 is controlled to be displayed on the prompt information window 102. That is, generation of the floating icon 20 is triggered by an operation performed by the user to the electronic device.

Specifically, the particular operation includes, but is not limited to, tapping the display screen, double tapping the display screen, shaking the electronic device (shaking), and pressing a particular position of the electronic device. In some embodiments, when the display screen is a flexible display screen, the particular operation may be received by the primary screen region 13, or by the secondary screen region 14, or by the bending region 11, which is not limited herein.

Preferably, the particular operation is an operation of shaking the electronic device, or an operation of pressing the electronic device. Since the user uses the electronic device mostly in a single-handed holding or double-handed holding posture, if the floating icon 20 is created by the operation of shaking the electronic device, or the operation of pressing the electronic device, the user may directly shake or press the electronic device without moving fingers or changing the current holding posture, which is convenient, rapid, and has no impact on the current operation, such that the user experience is good. In addition, when the particular operation is a tap operation or a double-tap operation, whether the operation is for creating floating icon 20 or for operating the current displayed application interface 101 may be determined based on different touch positions. For example, the floating icon 20 may be created by responding to a touch operation received by the bending region 11.

The floating icon 20 being displayed in the prompt information window 102 refers to a state in which the display screen simultaneously displays the floating icon 20 and the prompt information window 102, and the floating icon 20 floats in the prompt information window 102. In some embodiments, the floating icon 20 is circular, and when being slid, the floating icon 20 is similar to a gravity ball, such that a real sliding environment is simulated, and the user experience is improved. In other embodiments, the floating icon 20 may be further configured to a semi-transparent floating icon 20, a shape of the floating icon may be similar to a mouse pointer graph, and after being created, the floating icon is displayed in an outermost layer of the display screen.

In S13, position data in a three-dimensional space of the electronic device is acquired by the sensor, and the floating icon is controlled to move based on the position data.

The sensor includes, but is not limited to, a gravity sensor, an acceleration sensor, a direction sensor, a gyroscope, and the like. In this embodiment, the sensor is a gravity sensor.

In some embodiments, the position data includes an inclination direction; and that the floating icon is controlled to move based on the position data includes: the floating icon is controlled to move towards the inclination direction based on the inclination direction of the electronic device. For example, when it is detected that the electronic device inclines towards the left, the floating icon 20 is controlled to move towards the left; and when it is detected that the electronic device inclines towards the right, the floating icon 20 is controlled to move towards the right.

In step S14, the electronic device is controlled to perform a function corresponding to movement of the floating icon.

In the method for anti-disturbing according to the present disclosure, in response to receiving the prompt information, the floating icon 20 is created, and the floating icon 20 is controlled to be displayed in the prompt information window 102; the position data in the three-dimensional space of the electronic device is acquired by the sensor; and the floating icon 20 is controlled to move based on the position data, such that the electronic device is controlled to implement the corresponding function, and the prompt information may be processed without interrupting the current operation, thereby improving the user experience.

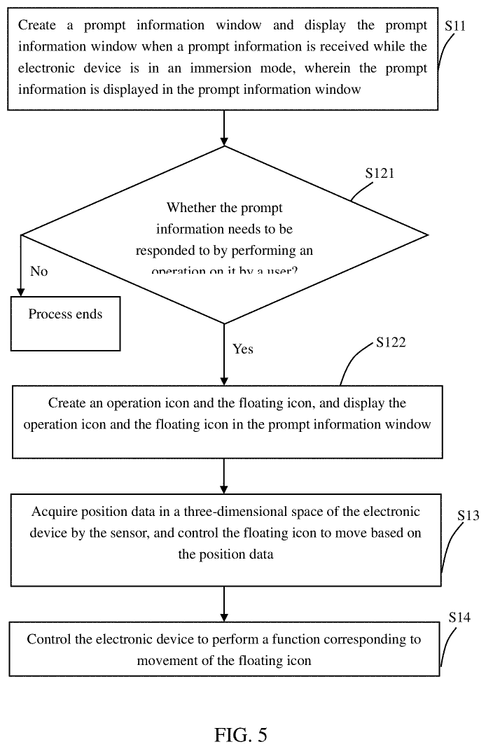

Referring to FIG. 5, in some embodiments, a difference between the method for anti-disturbing thereof and the method for anti-disturbing in FIG. 1 lies in that step S12 further includes the following steps:

In step S121, whether the prompt information needs to be responded to by performing an operation on it by a user is identified. If the prompt information needs to be responded to by performing the operation on it by the user, step S122 is performed; otherwise, the process ends.

Whether the prompt information needs to be responded by performing the operation on it by the user refers to whether the user needs to further perform the operation on the prompt information to trigger the electronic device to implement the corresponding function. When the application displaying the prompt information needs to receive a further operation from the user, and a corresponding function of the application would be implemented in response to the received operation (for example, a function key or icon needs to be touched by the user), it is determined that the user needs to perform a corresponding operation.

In step S122, an operation icon 21/22 and the floating icon 20 are created, and the operation icon 21/22 and the floating icon 20 are displayed in the prompt information window 102, wherein the operation icon 21/22 and the floating icon 20 are displayed at different positions of the prompt information window 102.

The operation icon 21/22 and the floating icon 20 are both in the same layer. In some embodiments, a first operation icon 21 and a second operation icon 22 are displayed in the prompt information window 102. That the electronic device is controlled to perform the function corresponding to movement of the floating icon includes: the electronic device is controlled to perform a first operation corresponding to the first operation icon 21 while the floating icon 20 moves towards to a first inclination direction; and the electronic device is controlled to perform a second operation corresponding to the second operation icon 22 while the floating icon 20 moves towards to a second inclination direction.

In some embodiments, the prompt information is an incoming call reminding information, the first operation icon 21 is an incoming call answer, and the second operation icon 22 is an incoming call hang-up. In this embodiment, the prompt information window 102 may further display an indicator 23. The indicator 23 indicates a movement direction of the floating icon 20, which may enable a user to visually view the operation, and hence facilitate the user's operation.

It should be noted that the first operation icon 21 and the second operation icon 22 correspond to different functions when the prompt information corresponds to different applications, which may be specifically defined according to the actual needs.

In some embodiments, the position data further includes an inclination degree; that the floating icon 20 is controlled to move based on the position data includes: a moving distance of the floating icon 20 on the display screen towards a predetermined direction is calculated in real time according to a predetermined conversion ratio based on the inclination degree; and the floating icon 20 is controlled to move towards the operation icon 21/22 by the moving distance. Specifically, the moving distance of the floating icon 20 on the display screen is calculated in real time according to the predetermined conversion ratio and based on the inclination degree. Since a movement distance is calculated based on a conversion ratio, the movement distance calculated in this way is a continuous data. A specific conversion ratio is associated with dimension of the display screen and the sensor.

In the present disclosure, the position data such as the inclination direction and the inclination degree of the electronic device, includes the inclination direction and the inclination degree relative to movement of the electronic device in a predetermined spatial posture. For example, the predetermined spatial posture may be a horizontal posture of the electronic device with the display screen facing up.

In some embodiments, that the electronic device is controlled to perform the function corresponding to the movement includes: in response to the floating icon 20 moving towards and coinciding with the operation icon 21/22, the electronic device is controlled to perform an operation corresponding to a coincided operation icon 21/22.

In this embodiment, the first operation icon 21 and the second operation icon 22 are displayed in the prompt information window 102; and that the electronic device is controlled to perform the operation corresponding to the coincided operation icon includes: in response to the floating icon 20 coinciding with the first operation icon 21, the electronic device is controlled to launch an application corresponding to the prompt information, to display, in a full screen, an application interface of the application in the display screen, and to stop displaying the prompt information window 102. In some other embodiments, that the electronic device is controlled to perform the operation corresponding to the coincided operation icon includes: in response to the floating icon 20 coinciding with the first operation icon 21, the electronic device is controlled to launch the application corresponding to the prompt information, to display, in a full screen, an application interface of the application in the bending region 11 of the display screen, and to stop displaying the prompt information window 102. As such, another application may be operated without affecting the current operation.

In some embodiments, that the electronic device is controlled to perform the operation corresponding to the coincided operation icon includes: in response to the floating icon 20 coinciding with the second operation icon 22, the electronic device is controlled not to respond the application corresponding to the prompt information, and to stop displaying the prompt information window 102.

In some embodiments, determining that the floating icon 20 coincides with the operation icon 21/22 includes identifying whether a time duration when the floating icon 20 floats onto the operation icon 21/22 is greater than a predetermined time duration; and determining that the floating icon 20 coincides with the operation icon 21/22 if the time duration is greater than the predetermined time duration. As such, a mal-operation caused when the floating icon 20 is slid over the operation icon may be prevented.

In some other embodiments, when an area of the floating icon 20 is less than an area of the first operation icon 21 or an area of the second operation icon 22, coincidence means that the floating icon 20 is totally included in the first operation icon 21 or the second operation icon 22; when the area of the floating icon 20 is greater than the area of the first operation icon 21 or the area of the second operation icon 22, coincidence means that the floating icon 20 totally covers the first operation icon 21 or the second operation icon 22. When the floating icon 20, the first operation icon 21, and the second operation icon 22 are irregular graphs, coincidence means that a center of the floating icon 20 coincides with a center of the first operation icon 21 or a center of the second operation icon 22.

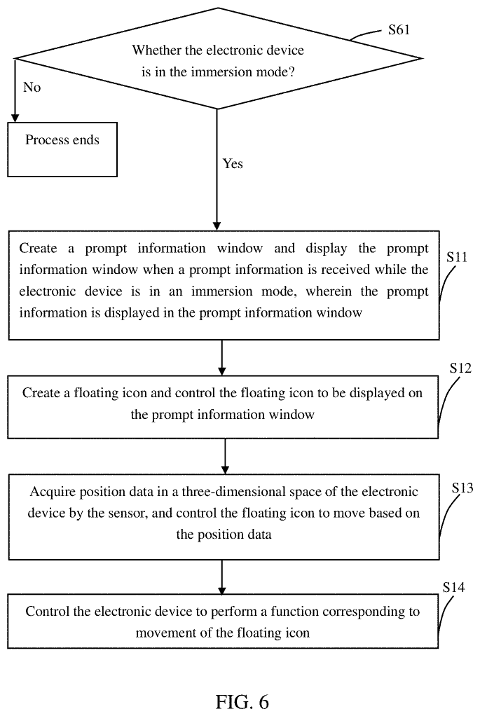

Referring to FIG. 6, in some embodiments, a difference between the method for anti-disturbing thereof and the method for anti-disturbing in FIG. 1 lies in that prior to step S11, the method further includes the following steps:

In step 561, whether the electronic device is in an immersion mode is identified. If the electronic device is in the immersion mode, step S11 is performed; otherwise, the process ends.

In this embodiment, when the electronic device is in a full-screen operating mode, the electronic device is determined to be in the immersion mode. For example, when the currently running application of the electronic device is in a full-screen operating state, that is, when a running interface of the application occupies a whole screen, the electronic device is determined to be in the immersion mode.

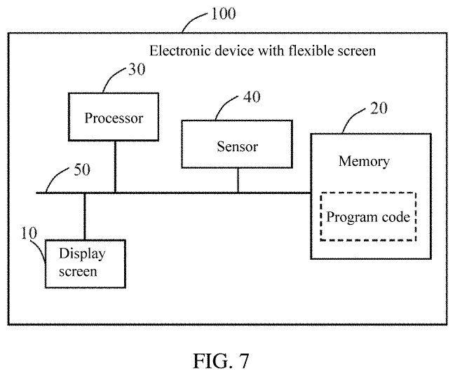

Referring to FIG. 7, FIG. 7 is a structural block diagram of an electronic device 100 according to an embodiment of the present disclosure. The electronic device 100 may be, but is not limited to, a mobile phone, a tablet computer, a laptop computer, a personal digital assistant (PDA), a portable media player (PMP), a navigation device, a wearable device, a smart bracelet, a pedometer, or the like, which is not limited herein. The electronic device 100 includes, but is not limited to, a display screen 10, a memory 20, a processor 30, and a sensor 40. Specifically, the display screen 10, the memory 20, the processor 30, and the sensor 40 are coupled together by a communication bus 50. A person skilled in the art may understand that FIG. 7 is only an example of the electronic device 100, and is not limited to the electronic device 100. The electronic device 100 may include more or less components than those illustrated in FIG. 7, or a combination of some components, or different components. For example, the electronic device 100 may further include an input-output device, a network access device, and the like.

The display screen 10 includes, but is not limited to, a liquid crystal display (LCD), a quantum dot light-emitting diode (QLED), an organic light-emitting diode (OLED), and the like, which is not limited herein.

The memory 20 may be configured to store a software program and/or module, and the processor 30 runs or executes the software program and/or module stored in the memory 20, calls data stored in the memory 20, and implements various functions of the electronic device 100. The memory 20 may include a program memory area and data memory area, wherein the program memory area may store operation systems and application programs needed by at least one function (for example, an audio play function, an image play function and the like); and the data memory area may store data created according to the use of the mobile phone (for example, audio data, phone book and the like). In this embodiment, a bending-instruction mapping relationship table is pre-stored in the memory 20.

In addition, the memory 20 may include a high-speed random-access memory, and may further include a non-volatile memory, for example, a hard disk, a RAM, an external hard disk, a smart media card (SMC), a secure digital (SD) card, a flash card, a plurality of external hard disk storage devices, flash devices, or other volatile solid storage devices.

The processor 30 may be a central processing unit (CPU), or may be a general-purpose processor, a digital signal processor (DSP), an application specific integrated circuit (ASIC), a field-programmable gate array (FPGA), or a programmable logic device, a discrete gate or transistor logic device, a discrete hardware component, or the like. The general processor may be a microprocessor or any customary processor or the like. The processor is a control center of the electronic device 100, and is connected to each part of the electronic device 100 by various interfaces and lines.

The sensor 40 is configured to sense position data of the electronic device 100 in a three-dimensional space, and includes, but is not limited to, a gravity sensor, an acceleration sensor, a direction sensor, a gyroscope, and the like. In this embodiment, the sensor is a gravity sensor.

The processor 30 is configured to create a prompt information window 102 and display the prompt information window 102 when a prompt information is received while the electronic device 100 is in an immersion mode. The prompt information is displayed in the prompt information window 102. The processor 30 is further configured to create a floating icon 20 and control the floating icon 20 to be displayed on the prompt information window 102. The processor 30 is further configured to acquire position data of the electronic device 100, and control the floating icon 20 to move based on the position data. The processor 30 is further configured to control the electronic device 100 to perform a function corresponding to the movement.

The immersion mode may be a game mode, a viewing mode, a meeting mode, or the like. The game mode refers to a mode in which the electronic device is currently running a game application in a full screen; the viewing mode refers to a mode in which the electronic device is currently displaying a video in the full screen; and the meeting mode refers to a mode in which the electronic device is active in the full screen and in a multi-person voice or video call. The electronic device being in the immersion mode indicates that a user is concentrating on what is doing by using the electronic device. For example, the user is playing game, watching a movie, making a meeting call with another user, or the like. In this case, the user does not want to be disturbed by the received prompt information.

According to the embodiments of the present disclosure, when the electronic device 100 is in the immersion mode and the prompt information is received, the processor 30 is configured to create the floating icon 20 and control the floating icon 20 to be displayed in the prompt information window 102, acquire the position data of the electronic device 100, and control the floating icon 20 to move based on the position data, thereby controlling the electronic device to perform the function corresponding to the movement. In this way, the prompt information may be processed without interrupting the current operation, thereby improving the user experience.

In some embodiments, in response to receiving the prompt information, the processor 30 is further configured to identify whether the prompt information needs to be responded to by performing an operation on it by the user; and if the prompt information needs to be responded to by performing the operation on it by the user, the processor 30 is further configured to create the operation icon 21/22 and the floating icon 20, and display the operation icon 21/22 and the floating icon 20 in the prompt information window 102; wherein the operation icon 21/22 and the floating icon 20 are displayed at different positions of the prompt information window 102. Whether the prompt information needs to be responded to by performing the operation on it by the user means that whether the user needs to further perform the operation on the prompt information to trigger the electronic device to implement the corresponding function. When the corresponding function of the application displaying the prompt information needs to be implemented by operating the prompt information by the user (for example, a function key or icon of the application needs to be touched by the user), it is determined that the user needs to perform a corresponding operation.

In some embodiments, the display screen 10 is a flexible display screen. The flexible display screen includes a bending region 11. When the electronic device 100 is in a folding state, the flexible display screen is foldably partitioned into a primary screen region 13 and a secondary screen region 14; and displaying, by the processor 30, the prompt information window 102 includes: controlling, by the processor 30, the electronic device to display the prompt information window 102 in the bending region 11, and controlling the electronic device to display an application interface 101 of an application in the primary screen region 13 or the secondary screen region 14 while the electronic device 100 in the immersion mode.

In some embodiments, the bending region 11 defines a folding line, the bending region 11 being partitioned by the folding line into a first side screen region 111 and a second side screen region 112, wherein the primary screen region 13 is connected to the first side screen region 11, and the secondary screen region 14 is connected to the second side screen region 112; and when the application interface 101 is displayed in the primary screen region 13, the prompt information window 102 is controlled, by the processor 30, to be displayed in the first side screen region 111; or when the application interface 101 is displayed in the secondary screen region 14, the prompt information window 102 is controlled, by the processor 30, to be displayed in the second side screen region 112. In this embodiment, the prompt information window 102 and the application interface 101 in the immersion mode are separately displayed, such that the prompt information window 102 does not cover a currently displayed application interface 101. Furthermore, it is not affected the user's watching the current application interface. In addition, since the first side screen region 111 or the second side screen region 112 deviates from a visual center of the user, distraction of the user's attention is decreased, and user experience is further improved.

In some embodiments, the position data includes an inclination direction; and controlling, by the processor 30 the floating icon 20 to move based on the position data includes: controlling, by the processor 30, based on the inclination direction of the electronic device 100, the floating icon 20 to move towards the inclination direction. In some embodiments, a first operation icon 21 and a second operation icon 22 are displayed in the prompt information window 102. Controlling, by the processor 30, the electronic device 100 to perform the function corresponding to the movement includes: controlling, by the processor 30, the electronic device 100 to perform a first operation corresponding to the first operation icon 21 in response to the floating icon 20 moving towards to a first inclination direction; and controlling, by the processor 30, the electronic device 100 to perform a second operation corresponding to the second operation icon 22 in response to the floating icon 20 moving towards to a second inclination direction.

In some embodiments, the prompt information is an incoming call reminding information, the first operation icon 21 is an incoming call answer, and the second operation icon 22 is an incoming call hang-up. In this embodiment, the prompt information window 102 may further display an indicator 23. The indicator 23 indicates a movement direction of the floating icon 20, which may enable a user to visually view the operation, and hence facilitate the user's operation.

It should be noted that the first operation icon 21 and the second operation icon 22 correspond to different functions when the prompt information corresponds to different applications, which may be specifically defined according to the actual needs.

In some embodiments, the position data further includes an inclination degree; controlling, by the processor 30, the floating icon 20 to move based on the position data includes: calculating a moving distance of the floating icon 20 on the display screen towards a predetermined direction in real time according to a predetermined conversion ratio based on the inclination degree; and controlling the floating icon 20 to move towards the operation icon 21/22 by the moving distance.

In some embodiments, controlling, by the processor 30, the electronic device 100 to perform the function corresponding to the movement includes: in response to the floating icon 20 moving towards and coinciding with the operation icon 21/22, controlling, by the processor 30, the electronic device 100 to perform an operation corresponding to a coincided operation icon 21/22.

In this embodiment, the first operation icon 21 and the second operation icon 22 are displayed in the prompt information window 102; and controlling, by the processor 30, the electronic device 100 to perform the operation corresponding to the coincided operation icon includes: in response to the floating icon 20 coinciding with the first operation icon 21, controlling, by the processor 30, the electronic device 100 to launch an application corresponding to the prompt information, to display, in a full screen, an application interface of the application in the display screen 10, and to stop displaying the prompt information window 102. In some embodiments, controlling, by the processor 30, the electronic device 10 to perform the operation corresponding to the coincided operation icon includes: in response to the floating icon 20 coinciding with the first operation icon 21, controlling, by the processor 30, the electronic device to launch an application corresponding to the prompt information, to display, in a full screen, an application interface of the application in the bending region 11 of the display screen 10, and to stop displaying the prompt information window 102. As such, another application may be operated without affecting the current operation.

In some embodiments, controlling, by the processor 30, the electronic device 100 to perform the operation corresponding to the coincided operation icon includes: in response to the floating icon 20 coinciding with the second operation icon 22, controlling, by the processor 30, the electronic device not to respond the application corresponding to the prompt information, and to stop displaying the prompt information window 102.

In this embodiment, determining that the floating icon 20 coincides with the operation icon 21/22 includes identifying, by the processor, whether a time duration when the floating icon 20 floats onto the operation icon 21/22 is greater than a predetermined time duration; and determining, by the processor 30, that the floating icon 20 coincides with the operation icon 21/22 if the time duration is greater than the predetermined time duration. As such, a mal-operation caused when the floating icon 20 is slid over the operation icon may be prevented.

In some embodiments, the processor 30 is further configured to identify whether the electronic device 100 is in the immersion mode. When the electronic device 100 is in a full-screen operating mode, the electronic device 100 is determined to be in the immersion mode. For example, when the currently running application of the electronic device 100 is in a full-screen operating state, that is, when a running interface of the application occupies a whole screen, the electronic device 100 is determined to be in the immersion mode.

It should be noted that, with respect to the above-described method embodiments, for brevity of description, the actions or steps are all described as a series of action combinations. However, a person skilled in the art shall understand that the embodiments of the present disclosure are not subjected to limitations of the action sequences described above. Further, based on the embodiments of the present disclosure, some steps may be performed in another or other sequences or may be simultaneously performed. In addition, a person skilled in the art should also know that the embodiments described in the description herein are all preferred embodiments, and all the involved actions and modules are not mandatory ones of the embodiments of the present disclosure.

In the above embodiments, descriptions give different particular emphases to various embodiments, and the portion of some embodiment that is not described may be referenced to the relevant description in other embodiments.

The steps in the method according to the embodiments of the present disclosure may be adjusted in sequence, may be combined, and may be deleted according to the actual needs.

The method for anti-disturbing according to the embodiments of the present disclosure may be implemented in hardware or firmware, or may act as software or computer code stored in the computer-readable storage medium such as a CD, ROM, RAM, floppy disc, hard disk, or magneto-optical disk, or act as computer code originally stored in a remote recording medium or non-transitory machine-readable medium, downloaded via a network, and stored in a local recording medium. In this way, the method described herein may be practiced by using a general-purpose computer or a special purpose processor or software stored in a recording medium in programmable or dedicated hardware such as an ASIC or an FPGA. It may be understood that in the art, the computer, the processor, the microprocessor, the controller, or a programmable hardware include a memory component such as the RAM, the ROM, a flash memory, or the like. When the computer, the processor, or the hardware implements the processing method described herein to access and execute software or the computer code, the memory component may store or receive the software or the computer code. In addition, when accessing the code configured to execute the processing described herein, the general-purpose computer is converted to a dedicated computer configured to execute the code described herein.

The computer-readable storage medium may be a solid-state memory, a memory card, a compact disc, or the like. The computer-readable storage medium stores computer program instructions, which, when called and executed by a computer, cause the computer to perform the method for anti-disturbing.

The embodiments of the present disclosure are described hereinafter in detail. The principles and embodiments of the present disclosure have been described with reference to specific examples, and the above embodiments are described only to help understanding of the method and core idea of the present disclosure. Persons of ordinary skill in the art may make modification or variations to the specific embodiments or application scopes according to the inventive concept of the present disclosure. In conclusion, this specification shall not be understood as limiting the present disclosure.

What is claimed is:

1. A method for anti-disturbing, being applied to an electronic device, the electronic device comprising a display screen and a sensor; the method comprising:
creating a prompt information window and displaying the prompt information window when a prompt information is received while the electronic device is in an immersion mode, wherein the prompt information is displayed in the prompt information window;
creating a floating icon and controlling the floating icon to be displayed in the prompt information window;
acquiring position data in a three-dimensional space of the electronic device by the sensor, and controlling the floating icon to move based on the position data; and
controlling the electronic device to perform a function corresponding to movement of the floating icon.

2. The method according to claim 1, wherein when the prompt information is received, the method further comprises:
identifying whether the prompt information needs to be responded to by performing a user's operation on the prompt information; and
creating an operation icon and the floating icon, and displaying the operation icon and the floating icon in the prompt information window while the prompt information needs to be responded to by performing the user's operation on the prompt information, wherein the operation icon and the floating icon are displayed at different positions of the prompt information window.

3. The method according to claim 1, wherein the display screen is a flexible display screen, the flexible display screen comprising a bending region, when the electronic device is in a folding state, the flexible display screen being foldably partitioned by the bending region into a primary screen region and a secondary screen region; and displaying the prompt information window further comprises: controlling the electronic device to display the prompt information window in the bending region, and controlling the electronic device to display an application interface of an application of the electronic device in the immersion mode in the primary screen region or the secondary screen region.

4. The method according to claim 3, wherein the bending region defines a folding line, the bending region is partitioned by the folding line into a first side screen region and a second side screen region, the primary screen region is connected to the first side screen region, and the secondary screen region is connected to the second side screen region; and when the application interface is displayed in the primary screen region, the prompt information window is controlled to be displayed in the first side screen region; or when the application interface is displayed in the secondary screen region, the prompt information window is controlled to be displayed in the second side screen region.

5. The method according to claim 2, wherein the position data comprises an inclination direction; and controlling the floating icon to move based on the position data further comprises:
controlling the floating icon to move towards the inclination direction based on the inclination direction of the electronic device.

6. The method according to claim 5, wherein a first operation icon and a second operation icon are displayed in the prompt information window; and
controlling the electronic device to perform the function corresponding to movement of the floating icon further comprises: controlling the electronic device to perform a first operation corresponding to the first operation icon in response to a movement of the floating icon towards to a first inclination direction; or
controlling the electronic device to perform a second operation corresponding to the second operation icon in response to a movement of the floating icon towards to a second inclination direction.

7. The method according to claim 5, wherein the position data further comprises an inclination degree; controlling the floating icon to move based on the position data further comprises: calculating in real time, based on the inclination degree, according to a predetermined conversion ratio, a moving distance of the floating icon on the display screen towards a predetermined direction; and controlling the floating icon to move towards the operation icon by the moving distance.

8. The method according to claim 5, wherein controlling the electronic device to perform the function corresponding to the movement of the floating icon further comprises: in response to a movement of the floating icon towards the operation icon and a coincidence of the floating icon with the operation, controlling the electronic device to perform an operation corresponding to a coincided operation icon.

9. The method according to claim 8, wherein a first operation icon and a second operation icon are displayed in the prompt information window; and controlling the electronic device to perform the operation corresponding to the coincided operation icon further comprises: in response to a coincidence of the floating icon with the first operation icon, controlling the electronic device to launch an application corresponding to the prompt information, to display, in a full screen, an application interface of the application in the display screen, and to stop displaying the prompt information window.

10. The method according to claim 9, wherein controlling the electronic device to perform the operation corresponding to the coincided operation icon further comprises: in response to a coincidence of the floating icon with the second operation icon, controlling the electronic device not to respond the application corresponding to the prompt information, and to stop displaying the prompt information window.

11. The method according to claim 8, wherein determining that the floating icon coincides with the operation icon further comprises:
identifying whether a time duration when the floating icon floats onto the operation icon is greater than a predetermined time duration; and
determining that the floating icon coincides with the operation icon when the time duration is greater than the predetermined time duration.

12. The method according to claim 6, wherein the prompt information is an incoming call reminding information, the first operation icon is an incoming call answer, and the second operation icon is an incoming call hang-up.

13. The method according to claim 1, further comprising: identifying whether the electronic device is in the immersion mode.

14. The method according to claim 13, wherein when the electronic device is in a full-screen operating mode, the electronic device is determined to be in the immersion mode.

15. An electronic device, comprising a display screen, a sensor, and a processor; wherein the sensor is configured to sense position data of the electronic device in a three-dimensional space, the processor is configured to create a prompt information window and display the prompt information window when a prompt information is received while the electronic device is in an immersion mode, wherein the prompt information is displayed in the prompt information window; and
the processor is further configured to create a floating icon and control the floating icon to be displayed in the prompt information window, control the floating icon to move based on the position data, and control the electronic device to perform a function corresponding to movement of the floating icon.

16. The electronic device according to claim 15, wherein when the prompt information is received, the processor is further configured to identify whether the prompt information needs to be responded to by a user's operation on the prompt information; and
the processor is further configured to create an operation icon and the floating icon, and display the operation icon and the floating icon in the prompt information window when the prompt information needs to be responded to by the use's operation on the prompt information, wherein the operation icon and the floating icon are displayed at different positions of the prompt information window.

17. The electronic device according to claim 15, wherein the display screen is a flexible display screen, the flexible display screen comprising a bending region, when the electronic device is in a folding state, the flexible display screen being foldably partitioned by the bending region into a primary screen region and a secondary screen region; and the processor is further configured to control the electronic device to display the prompt information window in the bending region, and control the electronic device to display an application interface of an application of the electronic device in the immersion mode in the primary screen region or the secondary screen region.

18. The electronic device according to claim 17, wherein the bending region defines a folding line, the bending region is partitioned by the folding line into a first side screen region and a second side screen region, the primary screen region is connected to the first side screen region, and the secondary screen region is connected to the second side screen region; and when the application interface is displayed in the primary screen region, the processor is further configured to control the prompt information window to be displayed in the first side screen region; or when the application interface is displayed in the secondary screen region, the processor is configured to control the prompt information window to be displayed in the second side screen region.

19. The electronic device according to claim 16, wherein the position data comprises an inclination direction; and the processor is further configured to control the floating icon to move towards the inclination direction based on the inclination direction of the electronic device.

20. A computer-readable storage medium, storing a control program for performing a method for anti-disturbing; wherein the control program, when running on a processor, causes the processor to:
create a prompt information window and display the prompt information window when a prompt information is received while the electronic device is in an immersion mode, wherein the prompt information is displayed in the prompt information window;
create a floating icon and control the floating icon to be displayed in the prompt information window;
acquire position data in a three-dimensional space of the electronic device by the sensor, and control the floating icon to move based on the position data; and
control the electronic device to perform a function corresponding to movement of the floating icon.
